(19) United States
(12) Patent Application Publication
(10) Pub. No.: US 2005/0289549 A1
(43) Pub. Date: Dec. 29, 2005

(54) Lock reservation methods and apparatus for multi-threaded environments

(76) Inventors: Michal Cierniak, Bellevue, WA (US); James M. Stichnoth, San Jose, CA (US)

Correspondence Address: GROSSMAN & FLIGHT LLC, Suite 4220, 20 North Wacker Drive, Chicago, IL, 60606-6357, US

(21) Appl. No.: 10/876,044

(22) Filed: Jun. 24, 2004

(51) Int. Cl. G06F 9/46

(52) U.S. Cl. 718/102

(57) ABSTRACT

Lock reservation methods and apparatus for multi-threaded environments are disclosed. An example method disclosed herein comprises determining whether the thread is a lock reservation owner of a lock corresponding to the object, at least one of acquiring the lock and releasing the lock if the thread is the lock reservation owner, and directing the lock reservation owner to unreserve the lock if the thread is not the lock reservation owner.

### FIELD OF THE DISCLOSURE

This disclosure relates generally to computers and, more particularly, to lock reservation methods and apparatus for multi-threaded environments.

### BACKGROUND

Software environments that support multi-threaded applications, for example, JAVA and the European Computer Manufacturers Association (ECMA) Common Language Infrastructure (CLI), typically include a synchronization mechanism for coordinating when one or more threads may access an object. As will be appreciated by those of ordinary skill in the art, a thread refers to a series of processor instructions organized into a single control flow of execution for processing one or more objects. An object is an instance of a class, where a class is a collection of data and methods to operate on such data. In the case of multiple threads of execution, care must be taken to prevent the multiple threads from modifying the same object simultaneously in a way that might place the object in an erroneous state. In particular, a thread may have critical sections that operate on objects that could be accessed simultaneously by another thread. Thus, multi-threaded systems typically provide specialized statements to protect the operation of a thread's critical section from being corrupted by one or more other threads accessing such a shared object during critical section execution.

For example, JAVA source code may include a synchronized statement to protect objects from being accessed simultaneously by different threads. Use of the synchronized statement enables acquisition of an exclusive lock of an object identified by the synchronized statement. Thus, a thread may be prevented from executing a critical section of code until it can obtain an exclusive lock on a particular object identified by a synchronized statement. Moreover, once such a lock is obtained, no other thread can access the locked object, thereby preventing inadvertent corruption of the processing being performed during execution of a critical section of code. Such a locking procedure may be used to ensure that multiple threads cannot access shared objects in a manner that could cause conflicting execution of critical sections of code at the same time. Of course, application of the synchronized statement is generally used in cases where a particular program creates multiple threads to share objects and/or methods. If only one thread ever accesses a particular object and/or method, there is no need to protect it with a synchronized statement.

A synchronized statement in JAVA source code is normally converted to JAVA virtual machine (JVM) instructions, because, as is known in the art, JAVA source code is first compiled into bytecodes (i.e., JVM language) prior to being executed by the JVM. For example, a synchronized statement may be converted to a monitorenter JVM instruction to gain/acquire an exclusive lock on an object. As a complement to the monitorenter instruction, a monitorexit JVM instruction is provided to unlock/release the exclusive lock on the object. Accordingly, if a thread successfully executes the monitorenter instruction upon an object, that thread gains temporary exclusive lock ownership of the object (i.e., it has gained a lock on the object to prevent other threads from accessing the critical sections of code). If another thread, or second thread, attempts to execute the monitorenter instruction upon the same object while the first thread has temporary exclusive ownership of the object, the second thread must wait (e.g., sleep or spin) until the first thread (i.e., the current lock owner) executes the monitorexit instruction to release its exclusive lock of the object.

Two state variables are often used to describe the lock state of an object. The first state variable is a lock owner that corresponds to the thread identifier of the thread that currently owns the lock. The lock owner may be set to a NULL value or a NULL thread for the case in which the lock is not owned by any thread. The second state variable is a lock recursion counter that may be used to indicate the number of times that the lock owner has acquired the lock (to support recursive locking). Typically, the lock state of an object is initialized to have a lock owner equal to a NULL value (corresponding to an unlocked state) and a lock recursion counter equal to zero.

Typically, a lockword is used to represent the lock state of an object. An example, known technique for object locking/synchronization is defined by Kawachiya, et al. in, Lock Reservation: JAVA Locks can mostly do without Atomic Operations,” Conference on Object-Oriented Programming, Systems, Languages, and Applications (OOPSLA), 2002, pp. 130-141. Kawachiya, et al. define a technique based on a lockword that may have two modes, namely, a reservation-mode and a base-mode, as indicated by a lockword mode bit. Additionally, a reservation-mode lockword may include the thread identifier state variable and the lock recursion counter state variable. Due to its relatively small size, the reservation-mode lockword may be stored inside a header of the object. In contrast, a base-mode lockword may include a number of data structures to support object locking/synchronization for scenarios in which a reservation-mode lockword may not be sufficient (e.g., in the case of lock contention during which a list of threads waiting to acquire the object lock may be needed). According to Kawachiya, et al., an object is initialized to have a reservation-mode lockword. The locking/synchronization procedure then converts the lockword to the base-mode, for example, when it becomes too large to fit in the object header (e.g., if there is lock contention and a list of waiting threads is required, if the lock recursion counter exceeds the maximum value that may be represented by the reservation-mode lockword, etc.). However, the locking/synchronization procedure does not convert a base-mode lockword back to a reservation-mode lockword (i.e., once the object lockword is converted to a base-mode it remains a base-mode lockword for the remainder of program execution).

In the locking/synchronization technique of Kawachiya, et al., the first thread to acquire the lock of an object is called the lock reservation owner of the object. The lock reservation owner may employ a simpler procedure for acquiring and releasing the object lock than a thread that is not the lock reservation owner. Additionally, if a thread that is not the lock reservation owner attempts to acquire the lock, the corresponding lockword will be converted to a base-mode lockword prior to lock acquisition by the thread: Subsequent lock acquisitions and releases will be based on the base-mode lockword as a base-mode lockword is not converted back to a reservation-mode lockword. During program execution, it is possible that two or more threads may attempt to lock an object at substantially the same time. For example, a thread that is not the lock reservation owner may attempt to acquire the lock of the object while a thread that is the lock reservation owner is in the process of performing its own lock acquisition or release of the same object. To prevent erroneous program behavior, Kawachiya, et al. require that threads are able to determine if the lock reservation owner is performing a lock acquisition or release and, if necessary, roll-back the execution of the lock reservation owner to an execution point prior to the start of the lock acquisition or release, respectively. Such a procedure may be difficult to implement and, moreover, reduce the execution efficiency of the overall program code.

### BRIEF DESCRIPTION OF THE DRAWINGS

FIG. 1 is a block diagram of an example managed run-time environment in which the example methods, apparatus and articles of manufacture described herein may be employed.

FIG. 2 is a block diagram of an example lock manager that may be used in the example managed run-time environment of FIG. 1.

FIG. 3 is a block diagram illustrating example lock acquisition and lock release units that may be used to implement the example lock manager of FIG. 2.

FIGS. 4A-4B illustrate possible states of an example lockword that may be used by the example lock manager of FIG. 2 and/or the example processes of FIGS. 8A-8C and 9

FIGS. 5A-5B is a flowchart representative of an example process that may be used to implement an example prior-art lock acquisition procedure for use by the example lock manager of FIG. 1.

FIG. 6 is a flowchart representative of an example process that may be used to implement an example prior-art lock release procedure for use by the example lock manager of FIG. 1.

FIG. 7 is a flowchart representative of an example process that may be used to implement the example lock manager of FIG. 2.

FIGS. 8A-8C is a flowchart representative of an example process that may be used to implement the example lock acquisition unit of FIG. 2.

FIG. 9 is a flowchart representative of n example process that may be used to implement the example lock release unit of FIG. 2.

FIGS. 10A-10B illustrate two example operations of the example lock manager of FIG. 2.

FIG. 11 is a schematic illustration of an example processor system that may carry out the processes of FIGS. 8A-8C and 9 to implement the example lock manager of FIG. 2.

### DETAILED DESCRIPTION

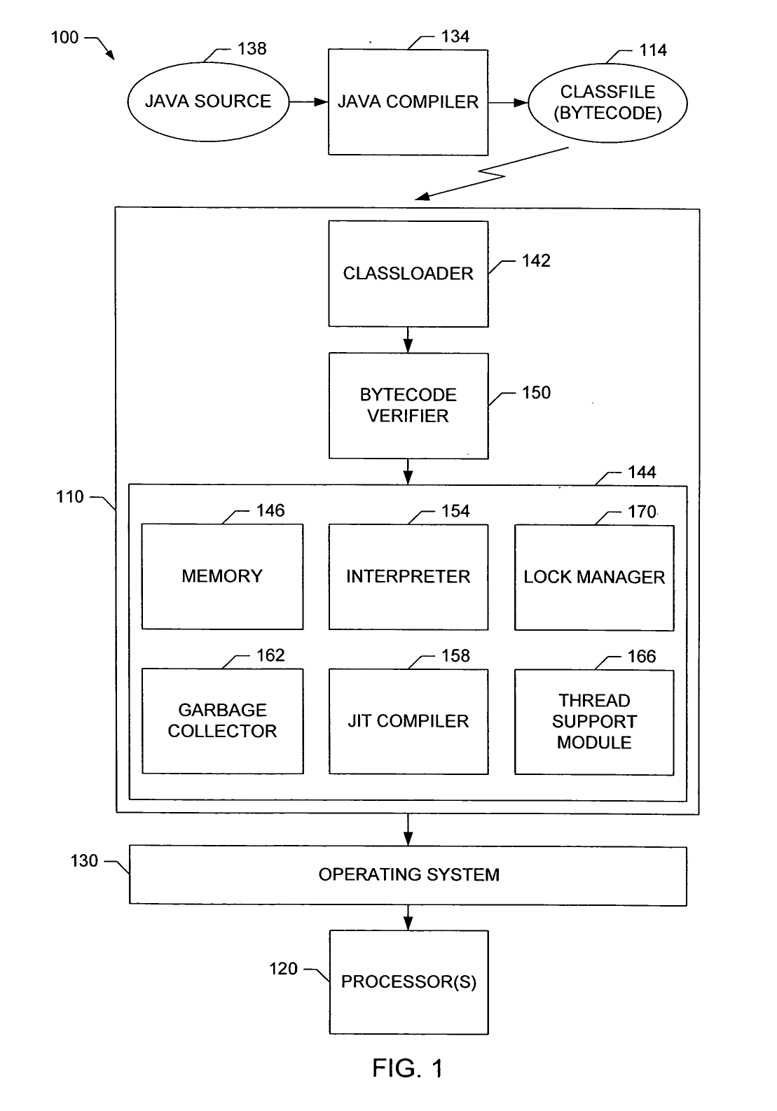

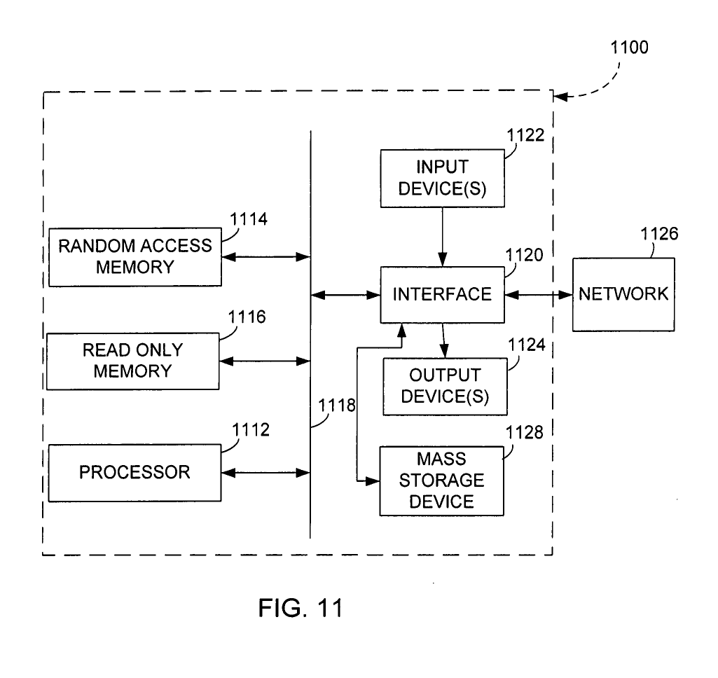

A block diagram of an example environment of use 100 in which the example methods, apparatus and articles of manufacture described herein may be employed is illustrated in FIG. 1. The example environment of use 100 may be implemented, for example, via one or more processor systems such as the example processor system 1100 of FIG. 11 described below. While the example of FIG. 1 corresponds to a JAVA-based managed run-time environment (MRTE), one having ordinary skill in the art will appreciate that the example methods, apparatus and articles of manufacture described herein may be applied to any similar MRTE environment of use, such as, for example, CLI and the associated language C#.

The example environment of use 100 includes an MRTE depicted as a JAVA virtual machine (JVM) 110 in FIG. 1. The example JVM 110 dynamically converts a program represented by machine-independent instructions, or bytecodes 114, into machine-dependent, or native, instructions and then executes the native instructions on one or more processors 120 (such as the processor 1112 discussed below). The JVM 10 may execute the native instructions via an operating system (OS) 130 specific to the one or more processors 120, such as the Microsoft Windows OS, the UNIX OS, the Linux OS, etc.

In the example of FIG. 1, the JVM 110 processes bytecodes 114 that are stored in a plurality of classfiles 114. Typically, a classfile 114 stores bytecodes 114 corresponding to a single JAVA class, including the interfaces, fields and methods that define the class. A classfile 114 may be created by a JAVA compiler 134 from JAVA program source code 138 written, for example, by a software developer. The JAVA compiler 134, the associated JAVA source code 138 and the resulting classfiles 114 (or bytecode 114) are well-known in the art and are not discussed further herein.

To process a classfile 114, the example JVM 110 includes a classloader 142 to locate one or more specific classfiles 114 corresponding to one or more specific classes and to load such classfiles 114 into an execution engine 144 of the JVM 110, for example, by storing a local image of a loaded classfile 114 into a local memory 146. Prior to storing the loaded classfile 114 to memory 146, the classloader 142 may invoke a bytecode verifier 150 to verify that the structure of the loaded classfile 114 is correct and conforms to the constructs of the JAVA language. In either case, the execution engine 144 of the JVM 110 then converts the loaded, machine-independent bytecodes into machine-dependent instructions using, for example, an interpreter 154 and/or one or more Just-In-Time (JIT) compilers 158.

The interpreter 154 converts the bytecode 114 into a set of machine-dependent instructions that implement the functionality of the bytecode 114 on the target processor(s) 120. In other words, the interpreter 154 provides an emulation layer to allow a bytecode 114 to be executed on the target processor(s) 120 as if the processor(s) 120 directly supported the JAVA instruction set. On the other hand, the JIT compiler 158 compiles a set of bytecodes 114 into a set of machine-dependent instructions for execution on the target processor(s) 120. The specific functionality of an individual bytecode 114 may not be exactly translated into machine-dependent instructions, but the overall functionality of the resulting set of machine-dependent instructions will be equivalent to the original set of bytecodes 114. Thus, the JIT compiler 158 may produce more optimal code than the interpreter 154. However, the interpreter 154 may be easier to implement than the JIT compiler 158.

To execute program code provided by the interpreter 154 and/or one or more JIT compilers 158, the execution engine 144 of the JVM 110 may define one or more storage areas in the local memory 146. For example, to support the execution of multiple, simultaneous threads, the JVM 110 may allocate a separate virtual program counter (pc) register and a separate JVM stack frame for each thread in the memory 146. The JVM stack frame may be used to store, for example, local variables and partial results corresponding to the associated execution thread. Additionally, the JVM 110 may define storage areas in the local memory 146 common to all threads. For example, such storage areas may include a heap to store objects that are created during program execution, a method area to store, for example, data and code used to implement the methods for a particular class, and a runtime constant pool to store constants associated with a particular class. To manage the runtime portion of the memory 146 efficiently, the JVM 110 may include a garbage collector 162, for example, to automatically deallocate objects from the heap to free memory for subsequent program execution.

To support the execution of multiple simultaneous threads, the execution engine 144 of the JVM 110 includes a thread support module 166. The thread support module 166 supports the creation of a thread by creating a thread object and executing the thread by invoking a start method of the thread. Additionally, the thread support module 166 may support preferential execution of threads through the use of various priority levels. Of particular interest in this disclosure, the execution engine 144 of the JVM 110 also includes a lock manager 170 to resolve conflicts that may occur as two or more threads attempt to access a same shared object.

The industry-standard specification corresponding to the example JVM 110 (as well as specifications for other managed run-time environments) defines procedures to support synchronization of objects between multiple threads. The JVM 110 provides a synchronization lock for each object. A thread may acquire ownership of an object by acquiring ownership of the lock associated with the object. Similarly, the thread may release ownership of the object by releasing ownership of the lock associated with the object. In the JAVA programming language, synchronization of objects and methods is implemented through the synchronized keyword. The specification for the JVM 110 defines the lock acquisition and release operations via the monitorenter and monitorexit bytecodes, respectively. However, the implementation of the monitorenter and monitorexit bytecodes is not defined.

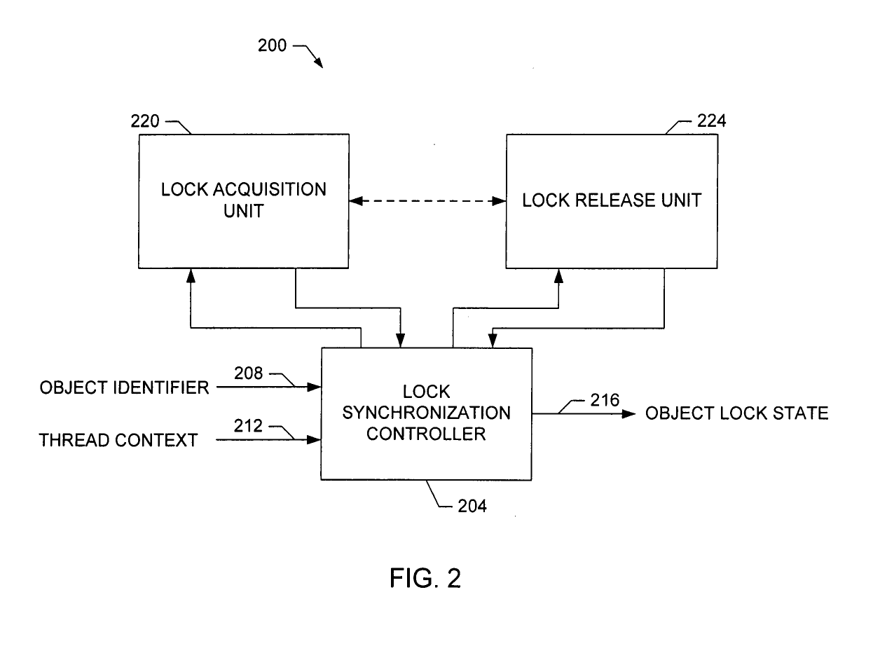

A block diagram of an example lock manager 200 that may be used to implement the example lock manager 170 of FIG. 1 is shown in FIG. 2. The example lock manager 200 acquires and releases a lock of an object for a thread based on a presumption that the majority of lock acquire and lock release operations will be performed by a lock reservation owner of the lock (i.e., a thread that is identified as owning a reservation-mode lockword corresponding to the lock of the object). For example, the lock manager 200 may determine that a reservation-mode lockword is associated with an object by examining a reservation-mode flag/indicator included in the lockword. Then, depending on the value of the reservation-mode flag/indicator, the lock manager 200 may determine whether the thread attempting to perform the locking operation on the object corresponds to a lock reservation owner field/value included in the reservation mode lockword. If the thread is the lock reservation owner, then the lock manager 200 may invoke a simplified procedure to perform the appropriate locking operation on the object. Conversely, if the presumption is incorrect and the thread seeking the lock is not the lock reservation owner, then the lock manager 200 may invoke a more complex and/or known procedure to perform the appropriate locking operation, which may include converting the reservation-mode lockword to a base-mode lockword.

As shown in FIG. 2, the lock manager 200 includes a lock synchronization controller 204 that accepts an object identifier input 208 and a thread context input 212 from an executing thread. The object identifier input 208 is used to identify an object to be synchronized and may include a unique object instance identifier, a lockword for the object, etc. The thread context input 212 is used to indicate the identity of a thread seeking to lock or unlock the object identified by the object identifier input 208, the operating state of the thread and the associated operation to perform on the lock of the object (e.g., to acquire the lock or release the lock and whether the thread is the lock reservation owner of the object). The lock synchronization controller 204 provides an object lock state output 216 to indicate the state of the lock of the object (e.g., initially acquired, recursively acquired, released/unlocked, throw exception, etc.).

Additionally, the lock synchronization controller 204 invokes a particular lock operation unit based on the type of locking operation to be performed on the lock of the object identified by the object identifier input 208. Example types of locking operations include a lock acquisition and a lock release. The lock synchronization controller 204 may determine the type of locking operation based on information provided via the thread context input 212. Such information may be determined, for example, by the interpreter 154 and/or JIT compiler 158 of FIG. 1 as part of the conversion from the bytecodes 114 to the set of machine-dependent instruction being executed by the thread identified by the thread context input 212.

To acquire the lock of an object, the example lock manager 200 includes a lock acquisition unit 220. If the lock synchronization controller 204 determines that a lock of an object should be acquired (e.g., based on the object identifier input 208 and the thread context input 212), then the lock acquisition unit 220 may determine whether the current mode of the lockword associated with the object supports reservation-based lock acquisition. For example, the lock acquisition unit 220 may be configured to perform reservation-based lock acquisition of an object only if the associated object has a reservation-mode lockword. Conversely, the lock acquisition unit 220 may be configured to employ to a base lock acquisition procedure if a base-mode lockword is associated with the object (e.g., due to previous contention of the object lock, a previous locking operation performed on the lock by a thread that was not the lock reservation owner, etc.).

If, for example, a reservation-mode lockword is associated with the object to be locked, then the lock acquisition unit 220 may determine whether the lock reservation owner is unassigned or the lock reservation owner is attempting to acquire the lock of the object. If the lock reservation owner of the lock is not assigned (e.g., as may be the case during the first lock acquisition of an object), the lock acquisition unit 220 may assign the thread identified by the thread context input 212 to be the lock reservation owner of the object. If, on the other hand, the lock reservation owner thread is attempting to acquire the lock, the lock acquisition unit 220 may, for example, simply increment a lock recursion count field/value of the reservation-mode lockword to indicate that the lock reservation owner has acquired the lock of the object (possibly recursively). If, however, a thread that is not the lock reservation owner is attempting to acquire the lock (and, thus, the lock may not be currently available) or if a base-mode lockword is associated with the object, the lock acquisition unit 220 may invoke a known base-mode lock acquisition procedure to obtain the lock for the thread (potentially after waiting for the lock to become available and/or converting the lockword from a reservation-mode to a base-mode). In either case, the lock acquisition unit 220 may then cause the lock synchronization controller 204 to update the lock state output 216 to indicate that the object lock has been acquired.

After the thread finishes executing code that required the locked object (e.g., as indicated by the thread context input 212), the lock synchronization controller 204 may invoke a lock release unit 224 to release the lock of the object. If a reservation-mode lockword is associated with the object and the lock reservation owner is attempting to release the lock, then the lock release unit 224 may, for example, simply decrement a lock recursion count field/value associated with the reservation-mode lockword. In this case, the value of the lock recursion count field indicates the number of times the lock reservation owner has recursively locked the object, with a value of zero corresponding to the case in which the object is unlocked. If, however, a base-mode lockword is associated with the object, the lock release unit 224 may invoke a known base-mode lock release procedure to release the lock for the thread. After the object lock is released, the lock release unit 224 may cause/signal the lock synchronization controller 204 to update the object lock state output 216 accordingly.

As indicated by the block diagram of FIG. 2, the lock acquisition unit 220 and the lock release unit 224 may be configured to communicate with each other. For example, the lock acquisition 220 may provide a request to unreserve the lockword associated with a locked object to the lock release controller 224. A request to unreserve the lockword may cause the lock release unit 224 to convert the lockword from a reservation-mode to a base-mode, for example, if the lock release unit 224 is currently releasing the lock for the lock reservation owner.

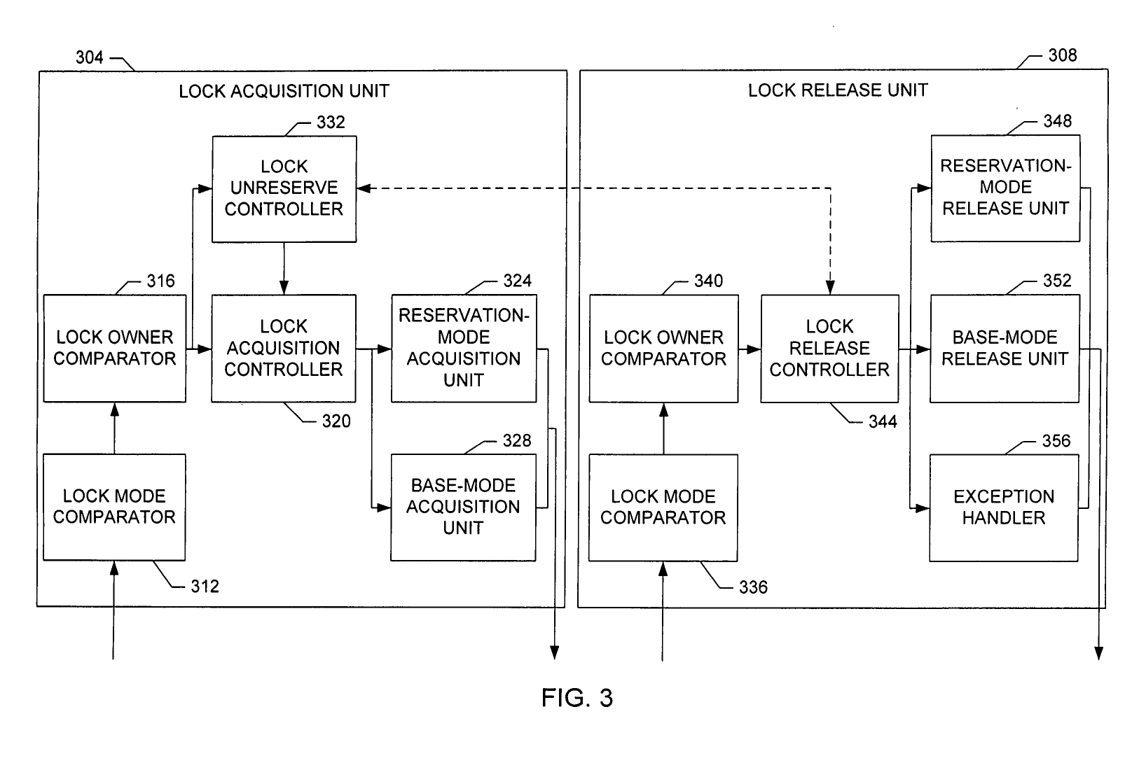

To better understand the operation of the example lock manager 200 of FIG. 2, a block diagram of an example lock acquisition unit 304 and a lock release unit 308 are shown in FIG. 3. The lock acquisition unit 304 and/or the lock release unit 308 may be used to implement the lock acquisition unit 220 and/or the lock release unit 224, respectively. As shown in FIG. 3, the example lock acquisition unit 304 includes a lock mode comparator 312 to determine, for example, whether a reservation-mode lockword or a base-mode lockword is associated with object to be locked (e.g., as indicated by the object identifier input 208 of FIG. 2). The lock acquisition unit 304 also includes a lock owner comparator 316 to determine whether the current thread attempting to acquire the object lock is the lock reservation owner of the object (e.g., by comparing a field in the reservation-mode lockword with thread identifier information provided via the thread context input 212). The lock owner comparator 316 may be configured to operate only if the lock mode comparator 312 determines that a reservation-mode lockword is associated with the object to be locked.

To determine the type of lock acquisition procedure to invoke to acquire the object lock, the example lock acquisition unit 304 includes a lock acquisition controller 320. The lock acquisition controller 320 may be configured to invoke a reservation-mode acquisition unit 324 if the lock mode comparator 312 determines that a reservation-mode lockword is associated with the object and the lock owner comparator 316 determines that the lock reservation owner (or a potential lock reservation owner) is attempting to acquire the object lock. Conversely, the lock acquisition controller 320 may be configured to invoke a base-mode acquisition unit 332 if, for example, the lock mode comparator 312 determines that a base-mode lockword is associated with the object to be locked, the lock owner comparator 316 determines that a thread that is not the lock reservation owner is attempting to acquire a reservation-mode lockword associated with the object, etc. To acquire the object lock, the reservation-mode acquisition unit 324 may increment a recursion counter field/value associated with the reservation-mode lockword. Additionally, the reservation-mode acquisition unit 324 may assign a thread to be the lock reservation owner of the object by setting a lock reservation owner thread identifier (ID) field of the reservation-mode lockword to correspond to the current thread attempting to acquire the object lock. In contrast, the base-mode acquisition unit 328 may employ a known acquisition procedure to acquire the object lock, while possibly resolving lock acquisition contention between multiple threads during the acquisition process.

Additionally, the example lock acquisition unit 304 may include a lock unreserve controller 332. The lock unreserve controller 332 may determine whether an object lock should be unreserved, that is, whether the lockword associated with the object should be converted from a reservation-mode to a base-mode. The lock unreserve controller 332 may make such a determination if, for example, a thread that is not the lock reservation owner attempts to acquire a reservation-mode lockword associated with the object. In such a case, the lock unreserve controller 332 may, for example, signal the lock acquisition controller 320 to cause the reservation-mode acquisition unit 324 to unreserve the object lock (i.e., convert the associated reservation-mode lockword to the corresponding base-mode lockword) after it has acquired the lock for the current thread (i.e., the thread that was previously the lock reservation owner of the object and whose lock acquisition was affected by the lock unreserve controller 332)

The example lock release unit 308 of FIG. 3 also includes a lock mode comparator 336 and a lock owner comparator 340 that are substantially similar to the lock mode comparator 312 and the lock owner comparator 316, respectively. Moreover, the lock mode comparators 312 and 336 may be implemented as a single unit and/or the lock owner comparators 316 and 340 may be implemented as a single unit. The lock release unit 308 includes a lock release controller 344 to determine the type of lock release operation to perform based on the outputs from the lock mode comparator 336 and/or the lock owner comparator 340. The lock release controller 344 may be configured to invoke a reservation-mode release unit 348 if the lock mode comparator 336 determines that a reservation-mode lockword is associated with the object and the lock owner comparator 340 determines that the lock reservation owner is attempting to release the object lock. However, if the lock mode comparator 312 determines that a base-mode lockword is associated with the object to be locked, the lock release controller 344 may be configured to invoke a base-mode release unit 352. If, however, the lock owner comparator 340 determines that a thread that is not the lock reservation owner is attempting to release a reservation-mode lockword associated with the object, the lock release controller 344 may be configured to invoke an exception handler 356 that employs a known exception handling process to throw an exception indicating that a thread attempted to inappropriately release a lock of an object. To release the object lock, the reservation-mode release unit 324 may decrement a recursion counter field/value associated with the reservation-mode lockword. In contrast, the base-mode release unit 328 may employ a known release procedure to release the object lock, while possibly resolving lock contention with other threads attempting to acquire the lock while the current thread is releasing the lock.

Additionally, the lock release controller 344 (or, more generally, the example lock release unit 308) may be coupled to the lock unreserve controller 332 of the example lock acquisition unit 304. As discussed above, the lock unreserve controller 332 may determine whether an object lock should be unreserved, that is, whether the lockword associated with the object should be converted from a reservation-mode to a base-mode. The lock unreserve controller 332 may make such a determination if, for example, a thread that is not the lock reservation owner attempts to acquire a reservation-mode lockword associated with the object. In such a case, the lock unreserve controller 332 may, for example, signal the lock release controller 344 to cause the reservation-mode release unit 348 to unreserve the object lock (i.e., convert the associated reservation-mode lockword to the corresponding base-mode lockword) after it has released the lock for the current thread (i.e., the thread that was previously the lock reservation owner of the object and whose lock release was affected by the lock unreserve controller 332).

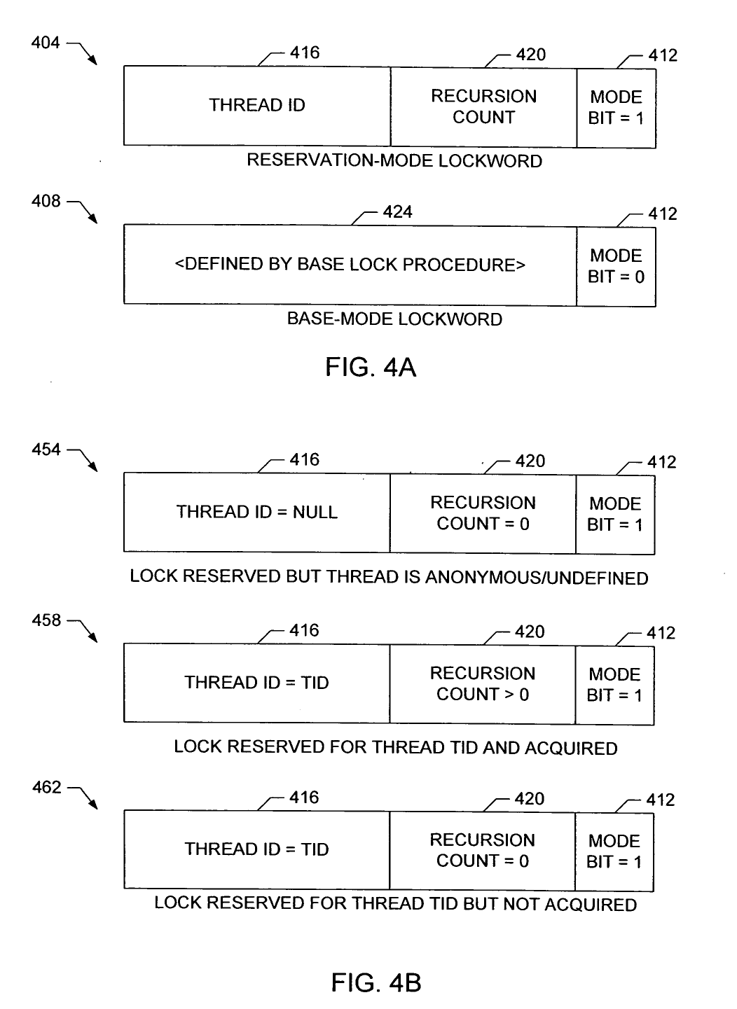

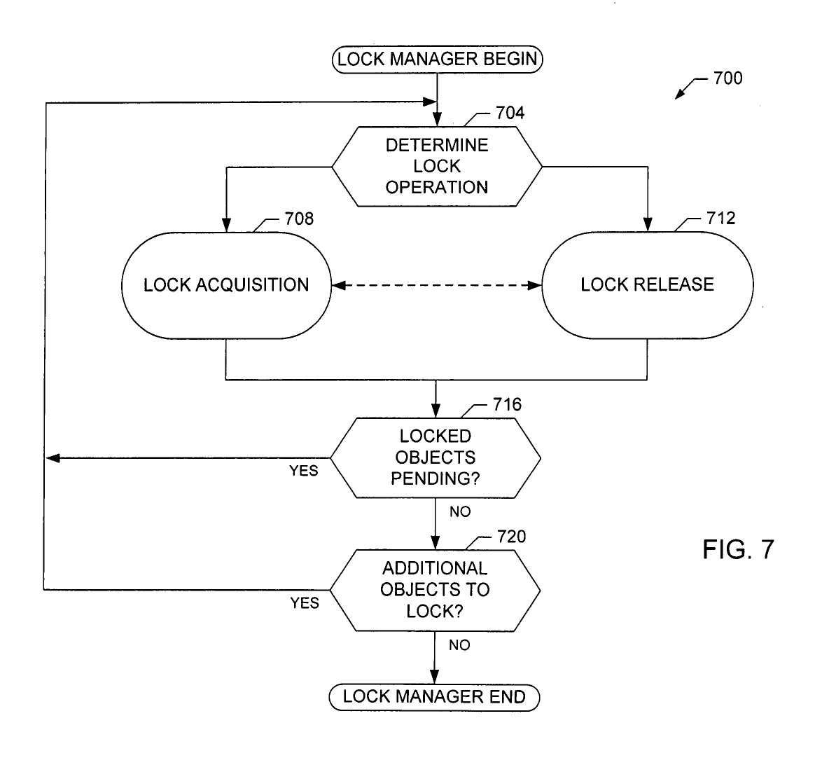

FIG. 4A illustrates an example lockword format that may be used by a disclosed implementation of, for example, the lock manager 170 of FIG. 1, the example lock manager 200 of FIG. 2, the example lock acquisition unit 304 and/or lock release unit 308 of FIG. 3 (as well as the example processes 700, 800 and 900 discussed below in connection with the descriptions of FIGS. 7-9). FIG. 4B illustrates example states of the example lockword format of FIG. 4A. Turning to FIG. 4A, an example lockword format that supports both a reservation-mode lockword 404 and an example base-mode lockword 408 is shown. The mode of the lockword (e.g., reservation-mode or base-mode) is indicated by a 1-bit lockword mode bit 412. For example, a value of 0 may indicate that the lockword is the base-mode lockword 408 and a value of 1 may indicate that the lockword is the reservation-mode lockword 404.

In addition to the lockword mode bit 412, the reservation-mode lockword 404 (e.g., with a lockword mode bit 412 equal to 1), includes a thread identifier (ID) field 416 and a recursion count field 420. The thread ID field 416 is used to store a value that corresponds to and may uniquely identify the thread that is the lock reservation owner of the object associated with the reservation-mode lockword 404. The recursion count field 420 is used to indicate the number of times the thread referenced by the thread ID field 416 has recursively acquired the object lock. For example, the recursion count field 420 may be incremented when the object lock is acquired and decremented when the object lock is released. The base-mode lockword 408, in contrast, includes a procedure-specific field 424 that is specific to the known base lock synchronization procedure employed to process the base-mode lockword 408. For example, the procedure-specific field 424 may include a pointer to a set of data structures to store locking information corresponding to the object lock. Such information may include a lock owner ID, a lock recursion counter, a list of threads waiting to acquire the lock associated with the object, etc.

Turning to FIG. 4B, three example states of the reservation-mode lockword 404 are shown. The first example state 454 corresponds to a case in which the reservation-mode lockword 404 has an anonymous owner, or in other words, has not been assigned a lock reservation owner. Thus, in the first example state 454, the thread ID field 416 is a NULL value and the recursion count field 420 is set to zero. The second example state 458 corresponds to a case in which the reservation-mode lockword 404 has been acquired by the reservation-mode lock owner. Thus, in the second example state 458, the thread ID field 416 is set to a value representative of the thread that is the lock reservation owner of the object (indicated by the value TID in FIG. 4B) and the recursion count value 420 is set to a non-zero value corresponding to the number of times the lock reservation owner (TID) has acquired the object lock. Finally, the third example state 462 corresponds to a case in which the reservation-mode lockword 404 has a lock reservation owner but is associated with an object that is unlocked (e.g., corresponding to a scenario in which the lock reservation owner has previously acquired (locked) and then released (unlocked) the object lock and no other thread has subsequently attempted to acquire the object lock). Thus, in the third example state 462, the thread ID field 416 is set to a value representative of the thread that is the lock reservation owner of the object (indicated by the value TID in FIG. 4B) and the recursion count value 420 is set to zero.

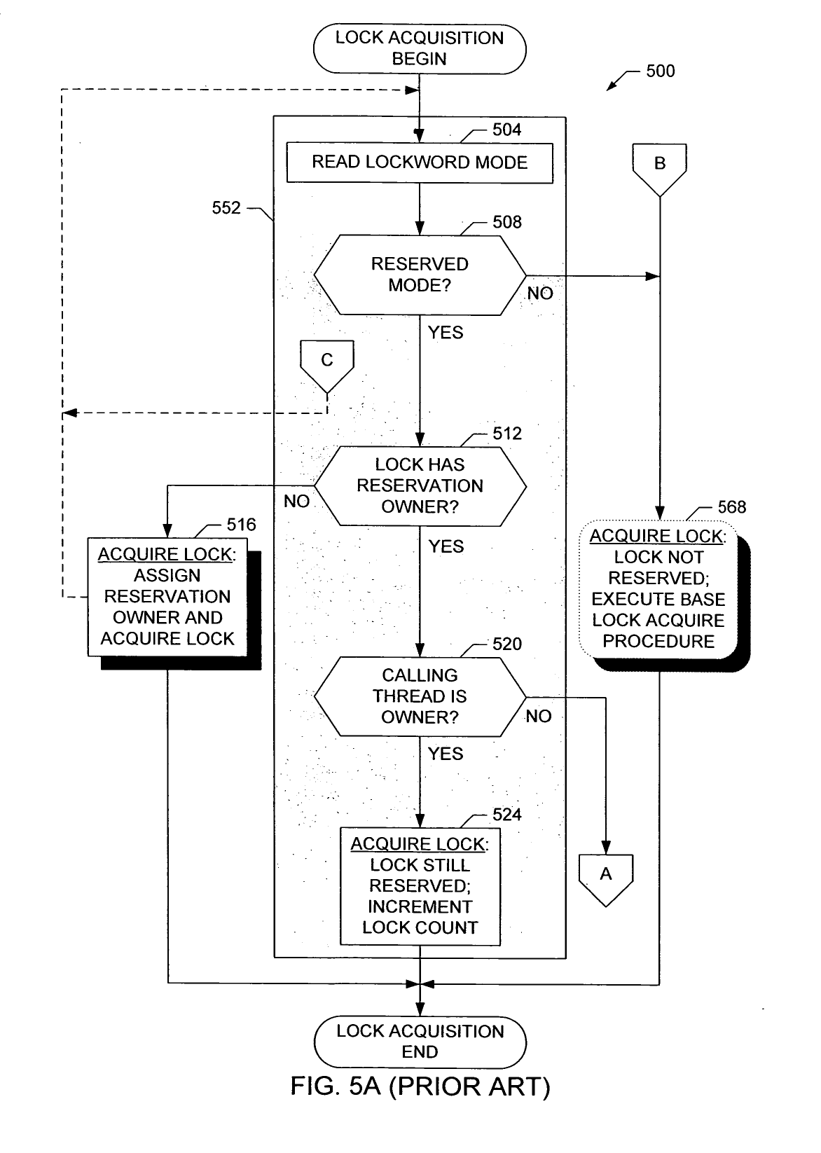

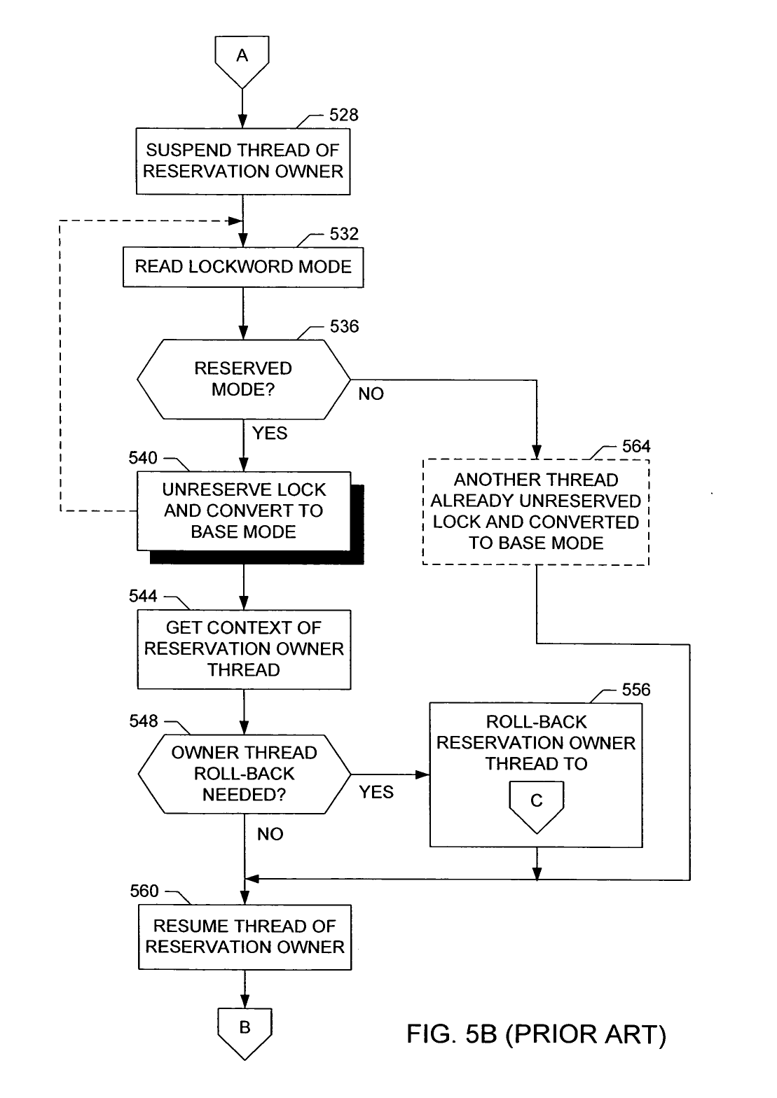

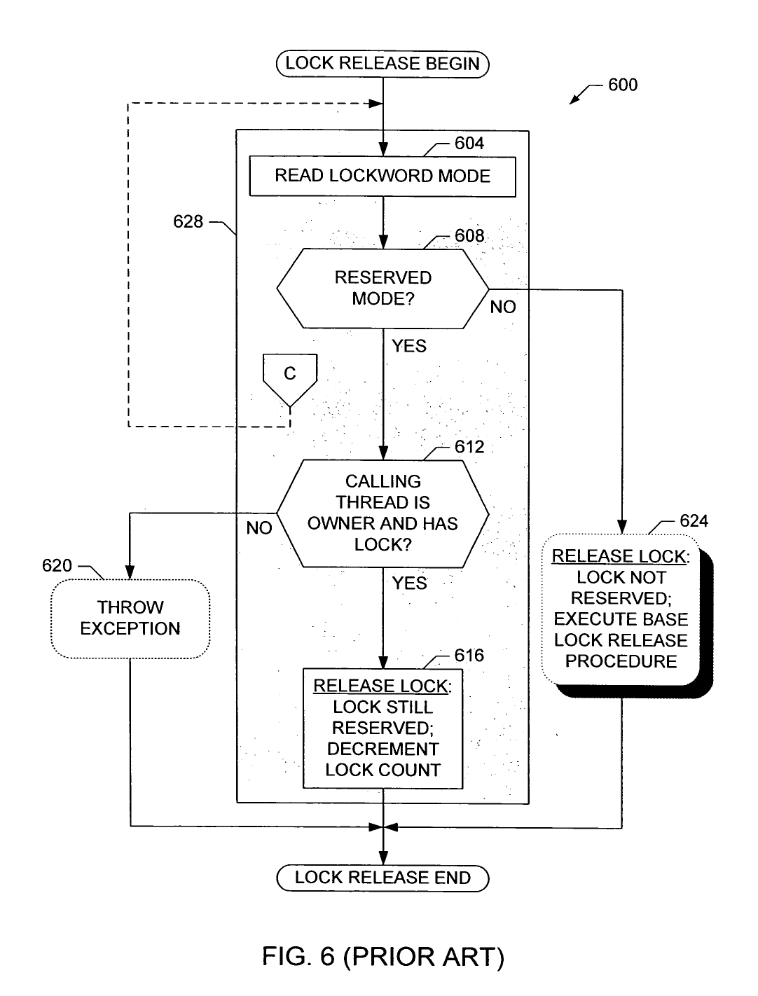

Flowcharts representative of known machine readable instructions for implementing the lock manager 170 of FIG. 1 are shown in FIGS. 5A-5B and 6. Flowcharts representative of example disclosed machine readable instructions for implementing the lock manager 170 of FIG. 1 and/or the lock manager 200 of FIG. 2 are shown in FIGS. 7-9. In the examples of FIGS. 7-9, the processes represented by each flowchart may be implemented by a set of machine readable instructions that may comprise one or more programs for execution by a processor, such as the processor 1112 shown in the example computer 1100 discussed below in connection with FIG. 11. The one or more programs may be embodied in software stored on a tangible medium such as a CD-ROM, a floppy disk, a hard drive, a DVD, or a memory associated with the processor 1112. However, persons of ordinary skill in the art will readily appreciate that the entire program and/or portions thereof could alternatively be executed by a device other than the processor 1112 and/or embodied in firmware or dedicated hardware in a well-known manner. For example, the lock manager 170 and/or the lock manager 200 could be implemented by any combination of software, hardware, and/or firmware. Further, although the example programs are described with reference to the flowcharts illustrated in FIGS. 7-9, persons of ordinary skill in the art will readily appreciate that many other methods of implementing the example methods and apparatus described herein may alternatively be used. For example, with reference to the flowcharts illustrated in FIGS. 7-9, the order of execution of the blocks may be changed, and/or some of the blocks described may be changed, eliminated, combined and/or subdivided into multiple blocks.

To better appreciate the properties and characteristics of the example lock manager 200 of FIG. 2, and to better understand the operation of the various processes illustrated by the flowcharts of FIGS. 7-9 below, prior-art processes to implement the lock manager 170 of FIG. 1 are shown in FIGS. 5A-5B and 6. Specifically, FIGS. 5A-5B illustrates a prior-art process 500 to acquire a lock of an object and FIG. 6 illustrates a prior-art process 600 to release the lock of the object. Although not shown, a controlling process may be used to determine which of the lock acquisition and lock release procedures should be invoked based on the state of an executing program thread.

Turning to FIG. 5A, the prior-art lock acquisition process 500 begins by reading the mode of the lockword associated with the object to be locked (block 504). The process 500 then determines whether a reservation-mode lockword is associated with the object to be locked (block 508). If, for example, a reservation-mode lockword is associated with the object to be locked (block 508), then the process 500 determines whether a lock reservation owner exists for the object lock (block 512). If the process 500 determines that a lock reservation owner does not exist (block 512), then the process 500 assigns the thread that invoked the prior-art lock acquisition process 500 to be the lock reservation owner of the object and acquires the lock of the object for the thread (block 516). The process 500 then ends. To prevent a second thread from attempting to acquire the lock while a first thread is already in the process of becoming the lock reservation owner and acquiring the object lock, block 516 may be implemented based on a single atomic operation (such as a cmpxchg.acq instruction on a processor belonging to the Intel Itanium processor family or a lock cmpxchg instruction on a processor belonging to the Intel IA-32 processor family). An atomic operation provides a thread (and/or a processor in a multi-processor system) with exclusive access to shared memory during the execution of the atomic operation. Thus, no other thread can modify the memory locations accessed by the atomic operation during its execution. (In FIG. 5A, a dotted line indicates that control will return from block 516 back to the initial lock acquisition block 504 if the atomic operation fails.)

If, however, a lock reservation owner already exists for the lock (block 512), then the process 500 determines whether the calling thread that invoked the prior-art lock acquisition process 500 is the lock reservation owner (block 520). If the calling thread is the lock reservation owner (block 520), then the process 500 acquires (possibly recursively) the lock for the thread by, for example, incrementing a lock recursion count/field included in the lockword of the object (block 524). The process 500 then ends.

However, if the lock has a reservation owner but it is not the calling thread (block 520), then the process 500 suspends the lock reservation owner thread in preparation for converting the reservation-mode lockword to a base-mode lockword (block 528 of FIG. 5B). The process 500 then reads again the mode of the lockword associated with the object whose lock is to be acquired (block 532). The process 500 determines whether a reservation-mode lockword is still associated with the object to be locked (block 536). If a reservation-mode lockword is still associated with the object (block 536), the process then unreserves the lockword of the object by converting the lockword to a corresponding base-mode lockword (while maintaining the current lock acquisition/release state of the lock) (block 540). Similar to block 516 of FIG. 5A, to prevent a second thread from attempting to acquire the lock while a first thread is already in the process of converting the lockword to a base-mode lockword, block 540 may be implemented based on a single atomic operation (such as a cmpxchg.acq instruction on a processor belonging to the Intel Itanium processor family or a lock cmpxchg instruction on a processor belonging to the Intel IA-32 processor family). (In FIG. 5B, a dotted line indicates that control will return from block 540 back to block 532 if the atomic operation fails.)

After the process 500 unreserves the lock of the object (block 540), the process 500 then gets the execution context of the previous lock reservation owner thread that was suspended at block 528 (block 544). Based on this execution context, the process 500 determines whether a roll-back of the previous reservation owner thread is required (block 548). Specifically, the process 500 determines whether the previous lock reservation owner was already attempting to acquire the same object lock and causing any of the blocks in the critical region 552 of FIG. 5A to be executed. In this case, the execution of the previous lock reservation owner thread will need to be rolled-back to block 504 (the start of the lock acquisition process) because unreserving the lock while the previous lock reservation owner thread was executing in the critical region 552 would cause the lock reservation owner thread to incorrectly process the base-mode lockword as if it were the reservation-mode lockword. Thus, the process 500 determines whether the previous lock reservation owner was operating in the critical region 552 (or a corresponding critical region 628 of the prior-art lock release process 600 of FIG. 6 described below) (block 548). If the previous lock reservation owner was operating in the critical region 552 (block 548), then the process 500 rolls-back the execution of the previous lock reservation owner to the start of the lock acquisition process (e.g., represented by the dotted line from point C in block 552 to block 504 of FIG. 5A). The process 500 may perform this roll-back function by, for example, modifying the program counter and/or stack associated with the previous lock reservation owner thread to correspond to an execution point just prior to block 504.

After the process 500 finishes rolling-back the execution context of the previous lock reservation owner (block 556), or if a reservation-mode lockword is not associated with the object (block 536), the process 500 then resumes the previous lock reservation owner thread (block 560). One having ordinary skill in the art will recognize that, if a reservation-mode lockword is no longer associated with the object at block 536, then another thread must have interceded and already unreserved the lock and converted the lockword to a base-mode lockword (indicated by the processing comment in block 564). In either case, after execution of the previous lock reservation owner thread is resumed (block 560), or if a base-mode lockword was originally associated with the object to be locked (block 508), the process 500 then invokes a known base-mode lock acquisition procedure to acquire the lock of the object based on the base-mode lockword (block 568). The process 500 then ends.

Turning to FIG. 6, the prior-art lock release process 600 begins by reading the mode of the lockword associated with the object to be locked (block 604). The process 600 then determines whether a reservation-mode lockword is associated with the object lock to be released (block 608). If, for example, a reservation-mode lockword is associated with the object to be locked (block 608), then the process 600 determines whether the calling thread that invoked the prior-art lock release process 600 is the lock reservation owner and had previously acquired the lock (block 612). If the calling thread is the lock reservation owner and had previously acquired the lock (block 612), then the process 600 releases the lock for the thread by, for example, decrementing a lock recursion count/field included in the lockword of the object (block 616). The process 600 then ends.

If, however, the calling thread is not the lock reservation owner or had not previously acquired the object lock (block 612), then the process 600 throws an exception (block 620). At block 620, the process 600 may use any known exception handling technique to throw an exception indicating that an invalid release attempt was performed (because a thread that did not own the lock attempted to unlock the associated object). The process 600 then ends. However, if the process 600 determines that a reservation-mode lockword is not associated with the object to be locked (block 608), the process 600 then invokes a known base-mode lock release procedure to release the lock of the object based on the base-mode lockword (block 624). The process 600 then ends.

As discussed previously, the prior-art lock acquisition process 500 of FIGS. 5A-5B may need to unreserve the lockword associated with the object being released by the prior-art lock release process 600 (e.g., if another thread is attempting to acquire the object lock while the calling thread that invoked the prior-art lock release process 600 is attempting to release the lock). Specifically, the prior-art lock acquisition process 500 may need to determine whether another thread (and particularly the lock reservation owner of the object) was already attempting to release the same object lock and causing any of the blocks in the critical region 628 of FIG. 6 to be executed. In this case, the execution of the calling thread that invoked the prior-art lock release process 600 will be suspended and rolled-back to block 604 (the start of the lock release process) because unreserving the lock while the calling thread was executing in the critical region 628 may cause the process 600 to operate on the base-mode lockword as if it were the reservation-mode lockword. Thus, the prior-art lock acquisition process 500 determines whether the prior-art lock release process 600 was operating in the critical region 628 and rolls-back the execution of the process 600 to the start of the lock release procedure (e.g., represented by the dotted line from point C in block 628 to block 604). The prior-art lock acquisition process 500 may perform this roll-back function by, for example, modifying the program counter and/or stack associated with the calling thread of the prior-art lock release process 600 to correspond to an execution point just prior to block 604.

Based on the understanding provided by the prior-art processes 500 and 600 of FIGS. 5A-5B and 6, respectively, an example lock manager process 700 that may be used to implement the example lock manager 200 of FIG. 2 is illustrated in FIG. 7. The example lock manager process 700 may be invoked, for example, during various execution stages of one or more threads when such threads operate on a synchronized object. For example, the example process 700 may be invoked to acquire or release a lock of an object.

The example lock manager process 700 begins by determining which type of locking operation to perform for the current (calling) thread on the lock of the object (block 704). Valid locking operations may include a lock acquisition and a lock release. For example, a JIT compiler, such as the JIT compiler 158 of FIG. 1, may use control flow graphs and/or data flow analyses to determine the types of locking operations to perform on the lock of an object at appropriate points during program execution. The JIT compiler 158 may then output compiled code that may be used by the lock manager 200 or lock manager process 700 to make the appropriate lock operation determination at block 704. Any known technique for determining the type of locking operation may be employed by the example process 700 and, thus, such techniques are not discussed further herein.

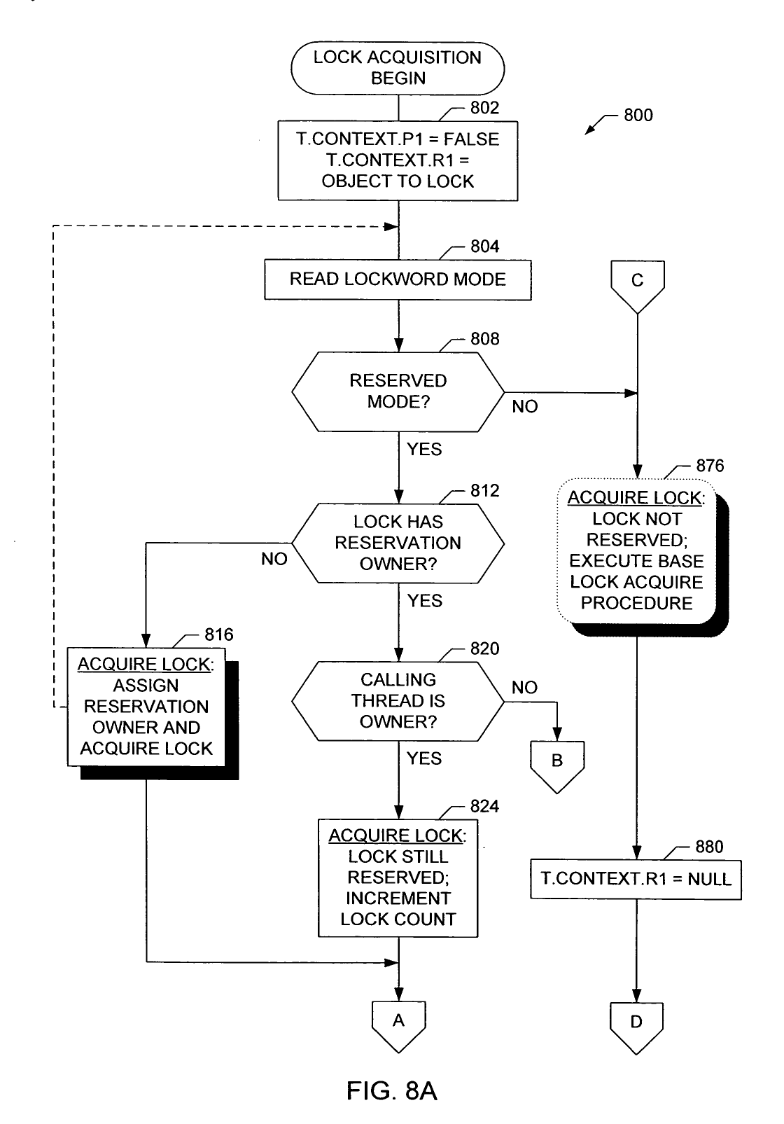

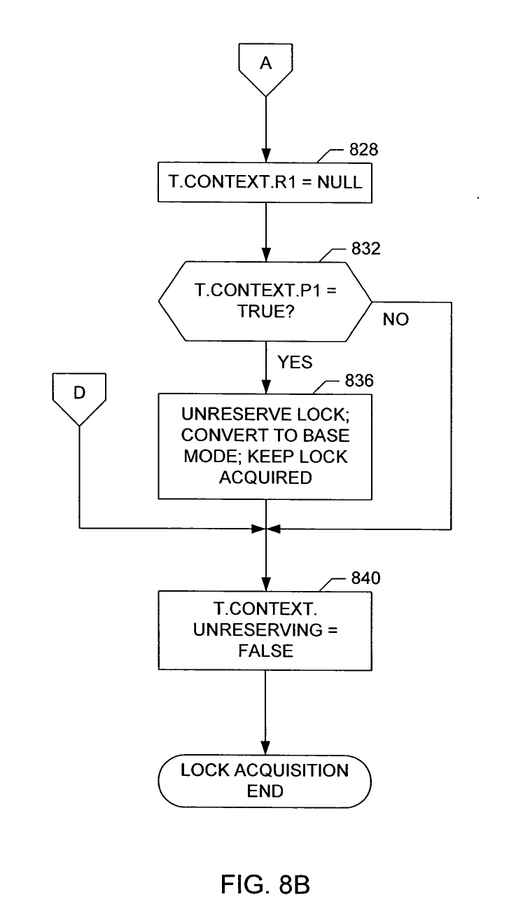

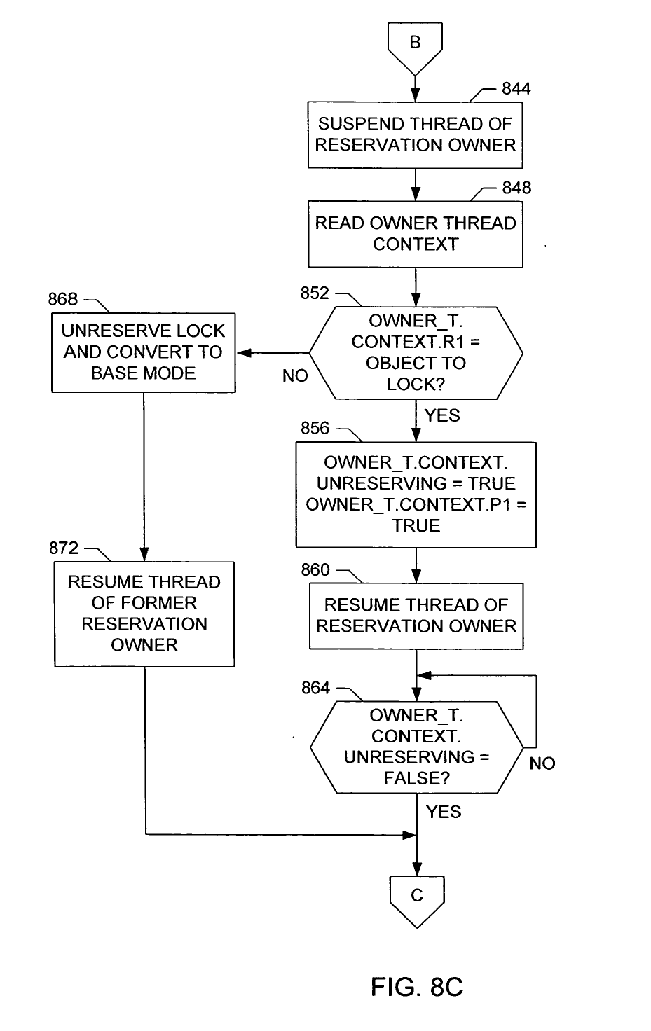

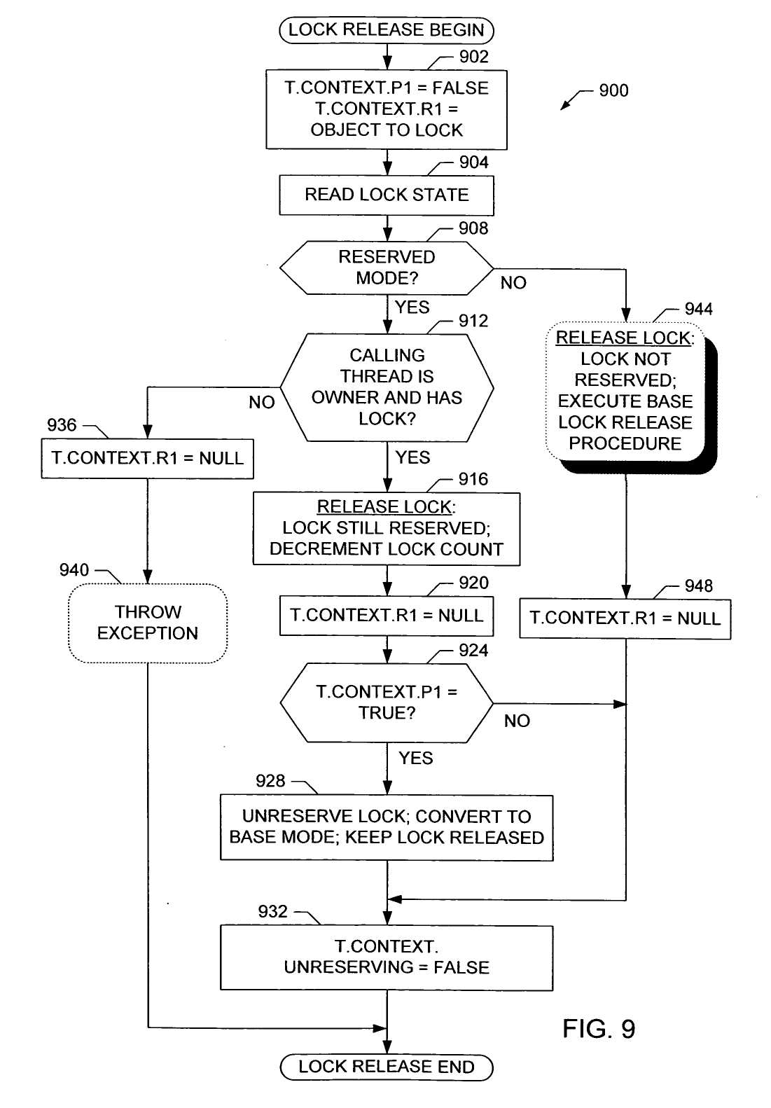

Based on the locking procedure determination made at block 704, control then proceeds to one of blocks 708 and 712. At block 708, the lock manager process 700 performs a lock acquisition operation on the lock of the object. At block 712, the lock manager process 700 performs a lock release operation on the lock of the object. The processing performed at blocks 708 and 712 is discussed in greater detail through the descriptions of FIGS. 8A-8C and 9, respectively, provided below.

After the processing at blocks 708 or 712 completes, the process 700 determines whether at least one locked object is still pending that will require a subsequent release at a future thread execution point (block 716). If any locked objects are pending (block 716), then control returns to block 704 and blocks subsequent thereto to allow the locks of such objects to be processed (as well as the locks of any additional objects to be locked). If, however, no locked objects are pending (block 716), the process 700 determines whether there are any additional objects to lock (block 720). If there are additional objects to lock (block 720), then control returns to block 704 and blocks subsequent thereto to allow the locks of such objects to be processed. If, however, there are no additional objects to lock (block 720), then the example process 700 ends. One having ordinary skill in the art will recognize that the conditional operations performed at blocks 716 and/or 720 may be replaced, for example, by an explicit or implicit determination regarding whether the program (or any thread of the program) is still executing. If the process 700 is still executing, control could then return to block 704 and subsequent blocks 708 and/or 712. Such a cycle could repeat until the process 700 (or all thread execution) terminates.

An example lock acquisition process 800 that may be used to perform the processing at block 708 of FIG. 7 and/or implement the lock acquisition unit 220 of FIG. 2 is shown in FIGS. 8A-8C. The example process 800 does not require the lock reservation owner thread roll-back procedure inherent to the prior-art lock acquisition process 500 if FIGS. 5A-5B. The example lock acquisition process 800 begins by initializing two thread context variables for the calling thread that invoked the process 800 (block 802 of FIG. 8A). The first of the two variables, p1, is used for inter-thread communications and, in particular, to allow a thread that is not the lock reservation owner of the lock to request that the lock reservation owner unreserve the object lock under certain circumstances. The variables p1 may be a register, such as a predicate register of a processor belonging to the Intel Itanium processor family. The second variable, r1, is used to indicate whether the lock reservation owner of the object is in the process of acquiring the object lock. For example, during lock acquisition the variable r1 may be set to point to the object being locked. Otherwise, the variable r1 may be set to a NULL value. Thus, to initialize these variables, the process 800 sets p1 to FALSE and r1 to point to the object to be locked (block 802).

After the processing at block 802 completes, the process 800 reads the mode of the lockword associated with the object to be locked (such as a lockword based on the lockword format illustrated in FIG. 4A) (block 804). The process 800 then determines whether a reservation-mode lockword (such as the reservation-mode lockword 404 of FIG. 4A) is associated with the object to be locked (block 808). If, for example, the reservation-mode lockword 404 is associated with the object to be locked (block 808), then the process 800 determines whether a lock reservation owner exists for the object lock (block 812). If the process 800 determines that a lock reservation owner does not exist (e.g., corresponding to the first example state 454 of FIG. 4B having the thread ID field 416 equal to a NULL value) (block 812), then the process 800 assigns the thread that invoked the lock acquisition process 800 to be the lock reservation owner of the object and acquires the lock of the object for the thread (block 816) (e.g., corresponding to the second example state 458 of FIG. 4B in which the thread ID field 416 is set to a value representative of the lock reservation owner and the recursion count field is set to a value of 1 to indicate that the lock was just acquired by the thread).

To prevent a second thread from attempting to acquire the lock while a first thread is already in the process of becoming the lock reservation owner and acquiring the object lock, block 816 may be implemented based on a single atomic operation (such as a cmpxchg.acq instruction on a processor belonging to the Intel Itanium processor family or a lock cmpxchg instruction on a processor belonging to the Intel IA-32 processor family). As discussed previously, an atomic operation provides a thread (and/or a processor in a multi-processor system) with exclusive access to shared memory during the execution of the atomic operation. Thus, no other thread can modify the memory locations accessed by the atomic operation during its execution. (In FIG. 8A, a dotted line indicates that control will return from block 816 back to block 804 if the atomic operation fails.)

If, however, a lock reservation owner already exists for the lock (e.g., corresponding to either the second example state 458 or the third example state 462 of FIG. 4B) (block 812), then the process 800 determines whether the calling thread that invoked the lock acquisition process 800 is the lock reservation owner (block 820). If the calling thread is the lock reservation owner (block 820), then the process 800 acquires (possibly recursively) the lock for the thread by, for example, incrementing a lock recursion count/field included in the lockword of the object (e.g., the recursion count field 420 of FIG. 4A) (block 824).

After the processing at either block 816 or block 824 completes, the process 800 then sets the variable r1 to a NULL value to indicate that the lock acquisition process for the lock reservation owner is complete (block 828 of FIG. 8B). The process 800 then determines whether another thread has invoked a process similar or identical to the process 800 and caused the context variables p1 of the lock reservation owner thread to be set to a logic TRUE value (block 832). The procedure by which another thread may cause p1 to be set to TRUE is discussed below. If the process 800 determines that p1 is set to TRUE (block 832), then the process 800 unreserves the object lock by converting the associated lockword to a base-mode lockword (block 836). The process 800, however, keeps the lock acquired with the now previous lock reservation owner still owning the object lock. To prevent possible race conditions and/or other erroneous behavior, block 836 may include a test of the lockword mode prior to conversion and/or employ an atomic operation during the conversion procedure. After the base-mode lockword conversion completes (block 836) or if p1 is FALSE (block 832), the process 800 then resets a third thread context variable, unreserving, to FALSE (block 840) to indicate that process 800 is finished processing a lock unreserve request, if any, as indicated by the variable p1. The example process 800 then ends.

However, if the lock has a reservation owner but it is not the calling thread (block 820), then the process 800 suspends the lock reservation owner thread in preparation for converting the reservation-mode lockword to a base-mode lockword (block 844 of FIG. 8C). The process 800 then reads the thread context variables associated with the lock reservation owner of the object (block 848). These variables include the thread context variables p1 and r1 of the lock reservation owner thread. The process 800 then determines whether the lock reservation owner thread context variable r1 points to the object that the calling thread desires to lock (block 852). If r1 points to the object to be locked (block 852), the process 800 then sets the p1 and the unreserving lock reservation owner thread context variables to TRUE to signal the lock reservation owner thread to unreserve the object lock after it finishes acquiring the lock (block 856). The process 800 then resumes the lock reservation owner thread that was suspended at block 844 (block 860). After execution of the previous lock reservation owner thread is resumed (block 860), the process 800 then waits (e.g., loops) until the lock reservation owner thread resets its unreserving thread context variable to FALSE (block 864), thereby indicating that the lock has been unreserved and the associated lockword converted to a base-mode lockword (see block 840 of FIG. 8B).

If, however, the lock reservation owner thread context variable r1 does not point to the object to be locked (block 852), then the process 800 unreserves the object lock by converting the associated lockword to a base-mode lockword (block 868). To prevent possible race conditions and/or other erroneous behavior, block 868 may include a test of the lockword mode prior to conversion and/or employ an atomic operation during the conversion procedure. The process 800 then resumes the lock reservation owner thread that was suspended at block 844 (block 872). After execution of the previous lock reservation owner thread is resumed (block 872) or after the lock reservation owner thread resets its unreserving thread context variable to FALSE and the process 800 resumes (block 864), the process 800 invokes a known base-mode lock acquisition procedure to acquire the lock of the object based on the base-mode lockword (block 876 of FIG. 8A). The process 800 then sets the variable r1 to a NULL value to indicate that the lock acquisition process for the calling thread is complete (block 880). Then, the process 800 resets the third thread context variable for the calling thread, unreserving, to FALSE (block 840 of FIG. 8B) to indicate that process 800 is finished processing a lock unreserve request, if any, as indicated by the variables p1. The exam process 800 then ends.

An example lock release process 900 that may be used to perform the processing at block 712 of FIG. 7 and/or implement the unbalanced lock release unit 224 of FIG. 2 is shown in FIG. 9. The example process 900 does not require the lock reservation owner thread roll-back procedure inherent to the example lock release process 600 of FIG. 6. Similar to the example lock acquisition process 800 of FIGS. 8A-8C, the example lock release process 900 begins by initializing two thread context variables for the calling thread that invoked the process 900 (block 902). The first of the two variables, p1, is used for inter-thread communications and, in particular, to allow a thread that is not the lock reservation owner of the lock to request that the lock reservation owner unreserve the object lock under certain circumstances. The variables p1 may be a register, such as a predicate register of a processor belonging to the Intel Itanium processor family. The second variable, r1, is used to indicate whether the lock reservation owner of the object is in the process of releasing the object lock. For example, during lock release the variable r1 may be set to point to the object whose lock is being released. Otherwise, the variable r1 may be set to a NULL value. Thus, to initialize these variables, the process 900 sets p1 to FALSE and r1 to point to the object whose lock is to be released (block 902).

After the processing at block 902 completes, the process 900 reads the mode of the lockword associated with the object lock to be released (such as a lockword based on the lockword format illustrated in FIG. 4A) (block 904). The process 900 then determines whether a reservation-mode lockword (such as the reservation-mode lockword 404 of FIG. 4A) is associated with the object to be locked (block 908). If, for example, the reservation-mode lockword 404 is associated with the object to be locked (block 908), then the process 900 determines whether the calling thread that invoked the lock release process 900 is the lock reservation owner and had previously acquired the lock (e.g., corresponding to the second example lockword state 458 of FIG. 4B) (block 912). If the calling thread is the lock reservation owner and had previously acquired the lock (block 912), then the process 900 releases the lock for the thread by, for example, decrementing a lock recursion count/field included in the lockword of the object (such as the recursion count field 420 of FIG. 4A) (block 916).

After the process 900 releases the object lock at block 916, the process 900 then sets the variable r1 to a NULL value to indicate that the lock release process for the lock reservation owner is complete (block 920). The process 900 then determines whether another thread has invoked a process similar or identical to the process 800 of FIGS. 8A-8C to acquire the object lock and, thus, has caused the variable p1 of the lock reservation owner thread context to be set to a logic TRUE value (block 924). The procedure by which another thread may cause p1 to be set to TRUE is discussed above in connection with the description of FIGS. 8A-8C. If the process 900 determines that p1 is set to TRUE (block 924), then the process 900 unreserves the object lock by converting the associated lockword to a base-mode lockword (block 928). To prevent possible race conditions and/or other erroneous behavior, block 928 may include a test of the lockword mode prior to conversion and/or employ an atomic operation during the conversion procedure. The process 900 then resets a third thread context variable, unreserving, to FALSE (block 932) to indicate that process 900 is finished processing a lock unreserve request, if any, as indicated by the variable p1. The example process 900 then ends.

If, however, the calling thread is not the lock reservation owner or had not previously acquired the object lock (block 912), then the process 900 resets the variable r1 to a NULL value (block 936) and throws an exception (block 940). At block 940, the process 900 may use any known exception handling technique to throw an exception indicating that an invalid release attempt was performed (because a thread that did not own the lock attempted to unlock the associated object). The example process 900 then ends. However, if the process 900 determines that a reservation-mode lockword is not associated with the object to be locked (block 908), the process 900 then invokes a known base-mode lock release procedure to release the lock of the object based on the base-mode lockword (block 944). After the base-mode lock release procedure completes (block 944), the example process 900 resets the variable r1 to a NULL value (block 948) and then ends.

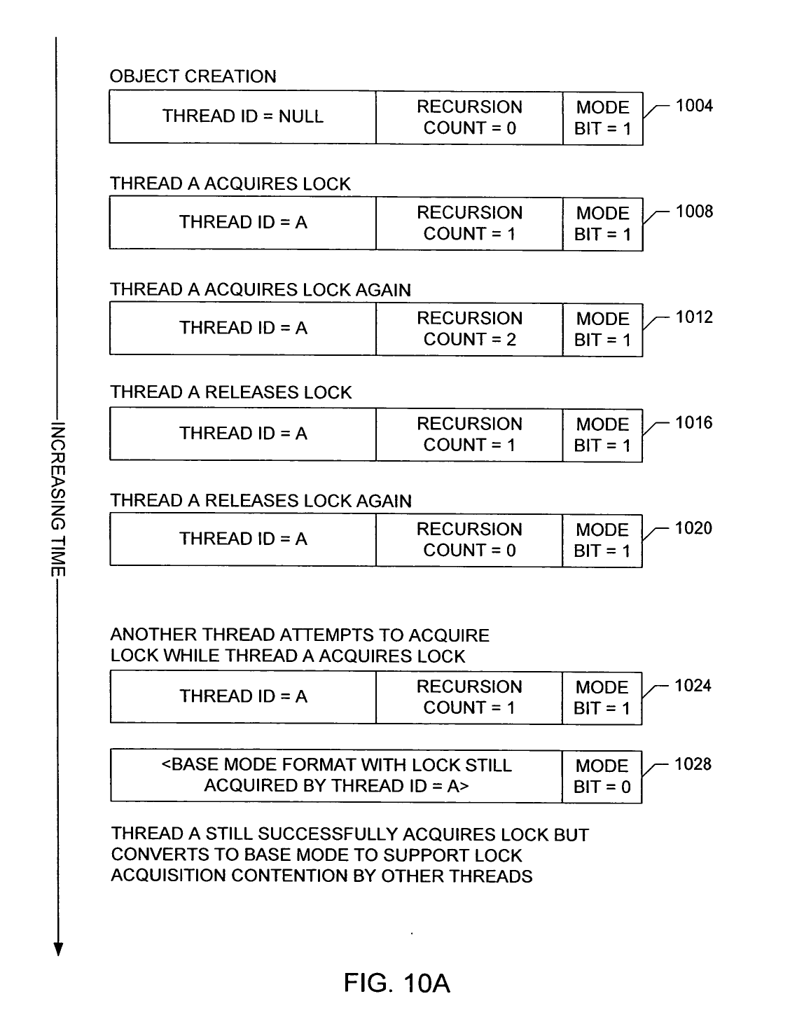

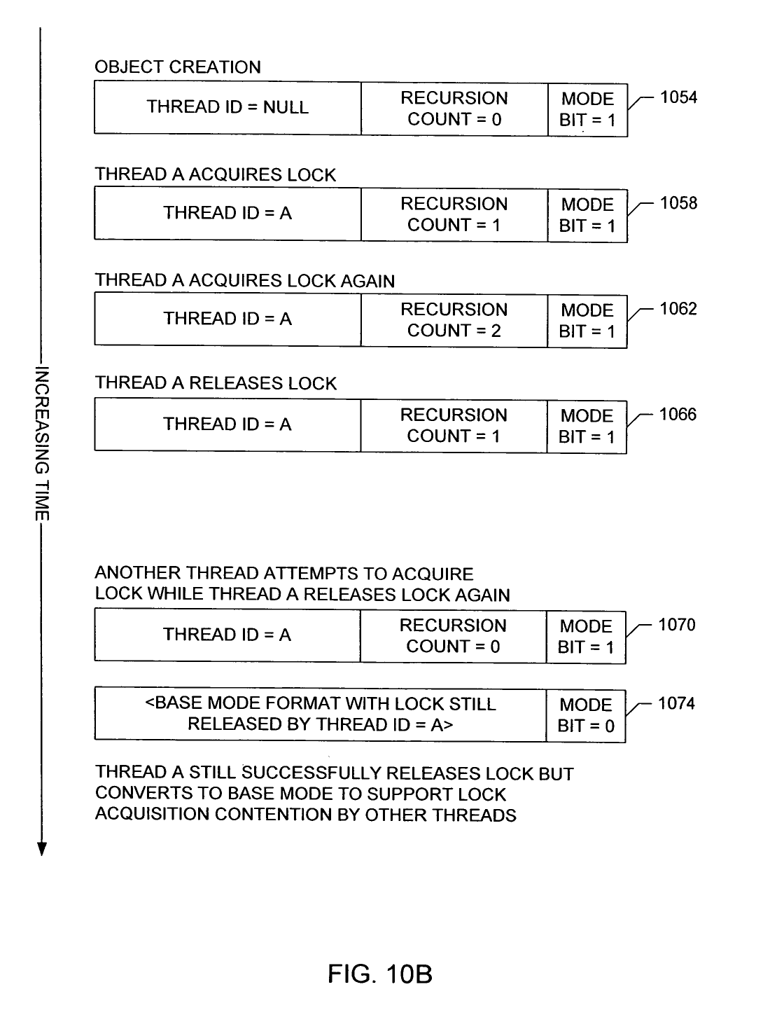

To assist in understanding the methods, apparatus and articles of manufacture described herein, two example operations of the example lock manager of FIG. 2 and/or the example processes 700, 800 and 900 of FIGS. 7, 8A-8C and 9, respectively, are shown in FIGS. 10A-10B. Specifically, FIGS. 10A-10B illustrate two sequences of lockword states corresponding to two sequences of lock acquisitions and releases performed by two threads on the lock of one object. Turning to FIG. 10A, the first example sequence of lockword states corresponding to the first example sequence of lock acquisitions and releases begins with a lockword state 1004 that corresponds to the initial reservation-mode lockword associated with an object as it is created. As expected, the lockword state 1004 has a lockword mode bit equal to 1 (to indicate that the lockword is a reservation-mode lockword), a thread ID field set to NULL (to indicate that there is no lock reservation owner currently assigned to the object) and a recursion count field set to zero (to indicate that the object lock is currently unlocked).

Next, a thread ‘A’ acquires the object lock, which corresponds to the next lockword state 1008. According to the example process 800 of FIGS. 8A-8C, the lockword state 1008 has a thread ID set equal to ‘A’ (to indicate that thread ‘A’ is the lock reservation owner) and a recursion count field equal to 1 to indicate that thread ‘A’ has acquired the object lock. Next, thread ‘A’ acquires the object lock again, which corresponds to lockword state 1012. According to the process 800, the lockword state 1012 still has a thread ID equal to ‘A’, but with a recursion count field now equal to two to indicate that the thread ‘A’ has recursively acquired the object lock a total of two times. Subsequently, the thread ‘A’ releases the object lock two times, which corresponds to lockword states 1616 and 1020. According to the example process 900 of FIG. 9, the recursion count fields of lockword states 1016 and 1020 are decremented due to the lock release operations. At lockword state 1020, the thread ‘A’ is still the lock reservation owner of the lock (e.g., the thread ID field is still set to ‘A’), but the object lock is currently unlocked (e.g., the recursion count field is equal to zero).

The following two lockword state 1024 and 1028 correspond to a lock acquisition scenario in which thread ‘A’ attempts to acquire the object lock again and at a slightly later time another thread (e.g., thread ‘B’) attempts to acquire the same object lock. According to the process 800, because thread ‘A’ is the lock reservation owner and acquires the object lock first, the lockword state 1024 indicates that the lockword is still in the reservation-mode (e.g., the lockword mode bit is equal to one) and that thread ‘A’ has acquired the lock (e.g., the recursion count field is equal to one). However, the subsequent lock acquisition attempt by thread ‘B’ causes the lockword to be converted to a base-mode, as indicated by the lockword state 1028 (e.g., the lockword mode bit is set to zero). According to the example process 800, the lock will still be owned by thread ‘A’ and thread ‘B’ will wait to acquire the lock via a base-mode lock acquisition procedure.

Turning to FIG. 10B, the second example sequence of lockword states corresponding to the second example sequence of lock acquisitions and releases begins with a lockword state 1054 that corresponds to the initial reservation-mode lockword associated with an object as it is created. As expected, the lockword state 1054 has a lockword mode bit equal to 1 (to indicate that the lockword is a reservation-mode lockword), a thread ID field set to NULL (to indicate that there is no lock reservation owner currently assigned to the object) and a recursion count field set to zero (to indicate that the object lock is currently unlocked).

Next, a thread ‘A’ acquires the object lock, which corresponds to the next lockword state 1058. According to the example process 800, the lockword state 1058 has a thread ID set equal to ‘A’ (to indicate that thread ‘A’ is the lock reservation owner) and a recursion count field equal to 1 to indicate that thread ‘A’ has acquired the object lock. Next, thread ‘A’ acquires the object lock again, which corresponds to lockword state 1062. According to the process 800, the lockword state 1062 still has a thread ID equal to ‘A’, but with a recursion count field now equal to two to indicate that the thread ‘A’ has recursively acquired the object lock a total of two times. Subsequently, the thread ‘A’ releases the object lock, which corresponds to lockword state 1066. According to the example process 900, the recursion count fields of lockword state 1016 is decremented due to the lock release operation.

The following two lockword state 1070 and 1074 correspond to a lock release scenario in which thread ‘A’ attempts to release the object lock again and at a slightly later time another thread (e.g., thread ‘B’) attempts to acquire the same object lock. According to the process 900, because thread ‘A’ is the lock reservation owner and releases the object lock first, the lockword state 1070 indicates that the lockword is still in the reservation-mode (e.g., the lockword mode bit is equal to one) and the thread ‘A’ has unlocked the lock (e.g., the recursion count field is equal to zero). However, the subsequent lock acquisition attempt by thread ‘B’ causes the lockword to be converted to a base-mode, as indicated by the lockword state 1074 (e.g., the lockword mode bit is set to zero). According to the example process 800, thread ‘B’ will then acquire the lock via a base-mode lock acquisition procedure. 100731 FIG. 11 is a block diagram of an example computer or processor system 1100 capable of implementing the apparatus and methods disclosed herein. The computer 1100 can be, for example, a server, a personal computer, a personal digital assistant (PDA), an Internet appliance, or any other type of computing device.

The system 1100 of the instant example includes a processor 1112. For example, the processor 1112 can be implemented by one or more Intel® microprocessors from the Pentium® family, the Itanium® family or the XScale® family. Of course, other processors from other families are also appropriate. A processor 1112 including one or more microprocessors may be used to implement the example environment of use 100 of FIG. 1, the example lock manager 200 of FIG. 2 and/or the example processes 700, 800 and 900 of FIGS. 7, 8A-8C and 9, respectively.

The processor 1112 is in communication with a main memory including a volatile memory 1114 and a non-volatile memory 1116 via a bus 1118. The volatile memory 1114 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is typically controlled by a memory controller (not shown) in a conventional manner.

The computer 1100 also includes a conventional interface circuit 1120. The interface circuit 1120 may be implemented by any type of well known interface standard, such as an Ethernet interface, a universal serial bus (USB), and/or a third generation input/output (3GIO) interface.

One or more input devices 1122 are connected to the interface circuit 1120. The input device(s) 1122 permit a user to enter data and commands into the processor 1112. The input device(s) can be implemented by, for example, a keyboard, a mouse, a touchscreen, a track-pad, a trackball, an isopoint and/or a voice recognition system.

One or more output devices 1124 are also connected to the interface circuit 1120. The output devices 1124 can be implemented, for example, by display devices (e.g., a liquid crystal display, a cathode ray tube display (CRT)), by a printer and/or by speakers. The interface circuit 1120, thus, typically includes a graphics driver card.

The interface circuit 1120 also includes a communication device such as a modem or network interface card to facilitate exchange of data with external computers via a network 1126 (e.g., an Ethernet connection, a digital subscriber line (DSL), a telephone line, coaxial cable, a cellular telephone system, etc.).

The computer 1100 also includes one or more mass storage devices 1128 for storing software and data. Examples of such mass storage devices 1128 include floppy disk drives, hard drive disks, compact disk drives and digital versatile disk (DVD) drives. The mass storage device 1128 and/or the volatile memory 1114 may be used to store, for example, the lockwords maintained and modified by processes 700, 800 and 900 of FIGS. 7, 8A-8C and 9, respectively.

As an alternative to implementing the methods and/or apparatus described herein in a system such as the device of FIG. 11, the methods and or apparatus described herein may alternatively be embedded in a structure such as a processor and/or an ASIC (application specific integrated circuit).

From the foregoing, persons of ordinary skill in the art will appreciate that the above disclosed methods and apparatus may be implemented in a static compiler, a managed run-time environment just-in-time (JIT) compiler, and/or directly in the hardware of a microprocessor to achieve performance optimization in executing various programs.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method to lock an object for a thread in a managed run-time environment comprising:
determining whether the thread is a lock reservation owner of a lock corresponding to the object;
at least one of acquiring the lock and releasing the lock if the thread is the lock reservation owner; and
directing the lock reservation owner to unreserve the lock if the thread is not the lock reservation owner.

2. A method as defined in claim 1 wherein determining whether the thread is the lock reservation owner comprises determining whether at least one of a reservation-mode lockword and a base-mode lockword is associated with the lock.

3. A method as defined in claim 2 wherein determining whether the thread is the lock reservation owner comprises determining whether a field of the reservation-mode lockword includes a value representative of the thread.

4. A method as defined in claim 1 wherein directing the lock reservation owner to unreserve the lock comprises suspending execution of the lock reservation owner.

5. A method as defined in claim 1 wherein to unreserve the lock the lock reservation owner converts a lockword associated with the lock to a base-mode lockword.

6. A method as defined in claim 1 further comprising waiting for the lock reservation owner to unreserve the lock if the thread is not the lock reservation owner.

7. A method as defined in claim 6 further comprising performing a base-mode lock acquisition procedure for the thread after the lock reservation owner unreserves the lock.

8. A method as defined in claim 1 wherein acquiring the lock comprises incrementing a value of a reservation-mode lockword associated with the lock.

9. A method as defined in claim 1 wherein acquiring the lock comprises determining whether the thread has been directed to unreserve the lock.

10. A method as defined in claim 1 wherein releasing the lock comprises decrementing a value of a reservation-mode lockword associated with the lock.

11. A method as defined in claim 1 wherein releasing the lock comprises determining whether the thread has been directed to unreserve the lock.

12. A method as defined in claim 1 further comprising initializing the lock by associating a reservation-mode lockword with the lock.

13. A method as defined in claim 12 wherein initializing the lock further comprises at least one of setting a first value of the reservation-mode lockword to indicate that the lock reservation owner is at least one of a NULL value and undefined, and setting a second value of the reservation-mode lockword to indicate that no lock acquisition operations have been performed on the lock.

14. A method as defined in claim 13 wherein the thread is assigned to be the lock reservation owner if the lock reservation owner was previously at least one of the NULL value and undefined.

15. An article of manufacture storing machine readable instructions that, when executed, cause a machine to:
determine whether a thread is a lock reservation owner of a lock corresponding to an object;
at least one of acquire the lock and release the lock if the thread is the lock reservation owner; and
direct the lock reservation owner to unreserve the lock if the thread is not the lock reservation owner.

16. An article of manufacture as defined in claim 15 wherein, to acquire the lock, the machine readable instructions cause the machine to at least one of increment a value of a reservation-mode lockword associated with the lock and determine whether the thread has been directed to unreserve the lock.

17. An article of manufacture as defined in claim 15 wherein, to release the lock, the machine readable instructions cause the machine to at least one of decrement a value of a reservation-mode lockword associated with the lock and determine whether the thread has been directed to unreserve the lock.

18. An article of manufacture as defined in claim 15 wherein the machine readable instructions further cause the machine to assign the thread to be the lock reservation owner if a value of a reservation-mode lockword associated with the lock indicates that the lock reservation owner was previously at least one of a NULL value and undefined.

19. An apparatus to lock an object for a thread in a managed run-time environment comprising:
a lock owner comparator to determine a lock reservation owner of a lock corresponding to the object;
a lock acquisition controller to acquire the lock for the thread; and
a lock unreserve controller to direct the lock acquisition controller to unreserve the lock if the thread is not the lock reservation owner.

20. An apparatus as defined in claim 19 further comprising a lock mode comparator to determine whether at least one of a reservation-mode lockword and a base-mode lockword is associated with the lock.

21. An apparatus as defined in claim 20 wherein the lock owner comparator is configured to determine the lock reservation owner of the lock if the reservation-mode lockword is associated with the lock.

22. An apparatus as defined in claim 19 further comprising a reservation-mode acquisition unit to acquire the lock for the thread if the thread is the lock reservation owner, and wherein the reservation-mode acquisition unit is configured to acquire the lock by incrementing a value of a reservation-mode lockword associated with the lock.

23. An apparatus as defined in claim 19 further comprising a base-mode acquisition unit to acquire the lock for the thread if the thread is not the lock reservation owner.

24. An apparatus as defined in claim 19 further comprising a lock release controller to release the lock for the thread.

25. An apparatus as defined in claim 24 wherein the lock release controller is coupled to at least one of the lock owner comparator and the lock acquisition controller to direct the lock release controller to unreserve the lock if the thread is not the lock reservation owner.

26. An apparatus as defined in claim 24 further comprising a reservation-mode release unit to release the lock for the thread if the thread is the lock reservation owner, and wherein the reservation-mode release unit is configured to release the lock by decrementing a value of a reservation-based lockword associated with the lock.

27. An apparatus as defined in claim 24 further comprising a base-mode release unit to release the lock for the thread if the thread is not the lock reservation owner.

28. A system to lock an object for a thread in a managed run-time environment comprising:
a processor configured to:
determine whether the thread is a lock reservation owner of a lock corresponding to an object;
at least one of acquire the lock and release the lock if the thread is the lock reservation owner; and
direct the lock reservation owner to unreserve the lock if the thread is not the lock reservation owner; and
a memory to store at least one of a reservation-mode lockword and a base-mode lockword associated with the lock.

29. A system as defined in claim 28 wherein the processor is further configured to at least one of increment a value of the reservation-mode lockword to acquire the lock if the thread is the lock reservation owner and decrement the value of the reservation-mode lockword to release the lock if the thread is the lock reservation owner.

30. A system as defined in claim 28 wherein the processor is further configured to assign the thread to be the lock reservation owner if a value of the reservation-mode lockword indicates that the lock reservation owner was previously at least one of a NULL value and undefined.
